(19) United States
(12) Patent Application Publication
(10) Pub. No.: US 2021/0214266 A1
(43) Pub. Date: Jul. 15, 2021

(54) ORGANIC GERMANIA AND SILICA SOURCES FOR MAKING OPTICAL FIBER PREFORMS

(71) Applicant: CORNING INCORPORATED, Corning, NY (US)

(72) Inventors: Curtis Robert Fekety, Corning, NY (US); Richard Michael Fiacco, Corning, NY (US); Ming-Jun Li, Horseheads, NY (US); Craig Daniel Nie, Corning, NY (US); Jeffery Scott Stone, Addison, NY (US); Pushkar Tandon, Painted Post, NY (US)

(21) Appl. No.: 17/145,471

(22) Filed: Jan. 11, 2021

Related U.S. Application Data
(60) Provisional application No. 62/961,381, filed on Jan. 15, 2020.

(51) Int. Cl. C03B 37/014; G02F 1/01

(52) U.S. Cl. CPC C03B 37/01446; C03B 37/01493; G02F 1/0115; G02F 1/0113

(57) ABSTRACT

Disclosed herein are methods for forming an optical fiber preform using organic silica and germania precursors. The method includes depositing soot composed of germanium dioxide and silica on a substrate, removing the substrate, conducting a dehydration step and one or more heating steps under an oxygen-containing atmosphere to form the preform. Also disclosed are optical fibers drawn from the preforms produced herein.

This Application claims priority under 35 USC § 119(e) from U.S. Provisional Patent Application Ser. No. 62/961,381 filed on Jan. 15, 2020 which is incorporated by reference herein in its entirety.

### BACKGROUND

Optical communication systems are becoming increasingly important for data transmission because they offer high transmission speeds and high bandwidth. The success of optical communication systems depends critically on the quality of optical fibers used in data transmission systems. Optical fibers must transfer optical data signals with high fidelity and low attenuation.

Optical fibers are made by drawing fibers from a preform. The preform is consolidated silica glass that includes a series of concentric regions of silica glass that differ in the level or type of dopant. Control of the spatial distribution, concentration, and/or type of dopant in the fiber preform creates regions that differ in refractive index. The differences in refractive index are manifest in fibers drawn from the preform and define the different functional regions of an optical fiber (e.g., core vs. cladding, low index depressions, tailored index profiles).

One conventional process for making optical fiber preforms is an outside vapor deposition process that entails deposition of silica (or doped silica) soot onto a silica (or doped silica) cane. The cane is fully consolidated glass with a generally cylindrical geometry and becomes the central portion of the fiber preform. The cane has the composition desired for the high index core region of the fiber ultimately drawn from the preform (and for this reason is often referred to as the core cane). The silica soot surrounds the cane and can be deposited as a single layer with a single composition or a series of layers that differ in composition, where the compositions of the one or more layers are designed to provide the index profile desired in the cladding region of the fiber ultimately drawn from the preform. The one or more soot cladding layers may include undoped silica and/or doped silica layers that differ in concentration or type of dopant.

Various processes are known that involve the production of metal oxides from a variety of feedstocks or precursors. Such processes require a feedstock and a means of catalyzing oxidation and combustion of the feedstock to convert the feedstock into finely divided aggregates called soot. This soot can be collected on deposition surfaces, ranging from a collection chamber to a rotating mandrel. The soot may be simultaneously or subsequently heat treated to form a high purity glass article. This process is usually carried out using specialized conversion site equipment having an arrangement of delivery tubes and flame generating burners.

Much of the initial research that led to the development of such processes, including flame hydrolysis, focused on the production of silica glass products such as bulk fused silica. Selection of an appropriate feedstock that can be converted into the desired silica glass composition is an important aspect of such research. Commercial production of silica glass by such a conversion process became and is continued to be dominated by the use of silicon tetrachloride (SiCl₄) as the feedstock's source of silicon. The high vapor pressure of silicon tetrachloride and its purity have made it a useful and convenient source of vapor for conversion into SiO₂ soot. This use of silicon tetrachloride provides a high purity silica glass and has been the commercially preferred method of manufacturing silica glass for use in optical waveguide products and particularly the manufacturing of optical waveguide fibers and their preforms. Such use of silicon tetrachloride in the manufacturing of optical waveguides has led to the adoption of other similar chloride-based feedstocks, which are compatible and used in conjunction with silicon tetrachloride to provide beneficial silica glass compositions and corresponding indices of refraction that are able to guide light. The silica glass dopant feedstock vapor GeCl₄ is used in conjunction with SiCl₄ vapors to form silica glass compositions doped with appropriate levels of germanium dioxide, which are used in the manufacturing of optical waveguides. This has led to the presently accepted use of SiCl₄ vapors and GeCl₄ vapors in the manufacturing of optical waveguide silica glass cores doped with GeO₂, even though such feedstocks result in the production of hazardous byproducts such as hydrochloric acid (HCl), for which pollution abatement systems are required.

Cladding soot is usually produced by flame reaction of one or more precursors. The flame reaction may be flame hydrolysis or flame combustion. In flame hydrolysis, water is present as a reactant and reacts with a soot precursor to form cladding soot. In flame combustion, water is not a reactant, but may be produced as a byproduct.

The manufacturing of optical fibers with germania-doped cores is currently somewhat expensive since large preform sizes and fast deposition rates have been difficult to achieve. Thus, strategies to reduce the cost include producing larger optical fiber preforms and using a faster deposition rate. Some success has been achieved in these areas as they relate to overcladding, especially when the overcladding is undoped silica. However, efforts have not been as successful for germania-doped cores, since index precision is needed in core deposition. Thus, core deposition is limited to small preforms (i.e., <10−15 kg) deposited using a small number of burners (i.e., <2−4), increasing the cost of producing such cores.

What is needed are methods for making large optical fiber preforms using a fast deposition rate and/or a large number of burners. Ideally, the methods would also employ organic precursors of silica and germania, thus avoiding the formation of hazardous byproducts such as HCl while simultaneously lowering manufacturing costs and reducing attenuation. The methods would further be reproducible in terms of amounts of germania capture. The subject matter of the present disclosure addresses these needs.

### SUMMARY

Disclosed herein are methods for forming an optical fiber preform using silica and germanium dioxide precursors. The method includes
(a) depositing particles comprising germanium dioxide and silica on a substrate, wherein the particles are produced by flame depositing a first composition comprising a silica precursor and a germanium dioxide precursor on the substrate, wherein the first composition is deposited on the substrate at a temperature of less than or equal to 1,250° C. to produce a soot preform coated on the substrate, and wherein at least one of the silica precursor or germanium dioxide precursor is an organic precursor;
(b) removing the substrate from the soot preform;
(c) heating the soot preform under a first atmosphere comprising oxygen at a first temperature;
(d) drying the soot preform after step (c) with a dehydration agent under a second atmosphere comprising oxygen; and
(e) heating the soot preform after step (d) under a third atmosphere comprising oxygen to form the optical fiber preform.

Also described herein are optical fibers produced from the preforms produced herein. The methods described herein reduce the cost to produce optical fiber preforms and, ultimately, optical fibers. For example, larger preforms can be manufactured by the methods described herein.

The advantages of the materials, methods, and devices described herein will be set forth in part in the description that follows, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below:

FIG. 1 depicts deposition of a soot layer on a bait rod.

FIG. 2 depicts deposition of a second soot layer on the soot layer shown in FIG. 1.

FIG. 3 shows that silica pre-passes create a uniform deposition of GeO₂ in the core and that an increase in GeO₂ is possible by cooling the preform surface further than standard practice. GeO/GeO₂ has very high capture on the early passes when the bait is cooler as seen for sample G, making the deposition non-uniform radially. The same concentration of tetraethoxygermane (TEOG) was used for both samples shown.

FIG. 4 shows a section of electron microprobe analysis (EMPA) of soot blanks showing germania striae due to increased capture on a comparatively cool preform surface from each pass of the burner and how it corresponds to lower soot density.

FIG. 5 shows the densities for OMCTS deposition to illustrate the impact that traverse speed and flow conditions have on soot density. Increasing traverse speed decreases density while maintaining constant flows and thus capture rates are similar. Data in FIG. 5 were from a 25 mm diameter tube.

FIG. 6 is a burner diagram with nomenclature and location of gases used in lathe recipes such as those disclosed herein.

FIG. 7 illustrates that an increase of germania is possible by increasing the traverse velocity, keeping the preform surface cooler. The increase in germanium capture is evident in samples A, B, and D as a result of the increasing traverse velocities.

FIG. 8 shows that sample F yielded the greatest germania capture, with an increase of 0.05% Δ above the next highest condition.

FIG. 9 shows that increasing fume stream O₂ appears to decrease germanium capture. Both samples shown were run with a traverse velocity of 4 cm/s. For sample E, the burner flows were modified, increasing fume stream O₂, resulting in a more oxidizing flame condition.

FIG. 10 shows a spectrum demonstrating that a low loss fiber (0.239 dB/km at 1550 nm) can be produced using organic silica and organic germania precursors.

FIG. 11 shows the refractive index profile for the fiber with the spectrum shown in FIG. 10.

FIG. 12 shows a fiber spectrum exhibiting a low OH peak intensity at 1380 nm, illustrating that adequate drying of the soot in consolidation is achieved using OMCTS when using a consolidation temperature of 1,050° C. instead of 1,200° C.

FIG. 13 shows a relative refractive index profile of a preform with a Ge-doped silica core portion formed from GeCl₄ and OMCTS and an undoped silica cladding portion formed from OMCTS.

### DETAILED DESCRIPTION

Before the present materials, articles and/or methods are disclosed and described, it is to be understood that the aspects described below are not limited to specific compounds, synthetic methods, or uses, as such may, of course, vary. It is also to be understood that the terminology used herein is for the purpose of describing particular aspects only and is not intended to be limiting.

In the specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “an alkaline earth metal oxide” in a glass composition includes mixtures of two or more alkaline earth metal oxides and the like.

“Optional” or “optionally” means that the subsequently described event or circumstance can or cannot occur, and that the description includes instances where the event or circumstance occurs and instances where it does not. For example, the first composition described herein may optionally contain an organic silica precursor, where the organic silica precursor may or may not be present.

As used herein, the term “about” is used to provide flexibility to a numerical range endpoint by providing that a given numerical value may be “a little above” or “a little below” the endpoint without affecting the desired result. For purposes of the present disclosure, “about” refers to a range extending from 10% below the numerical value to 10% above the numerical value. For example, if the numerical value is 10, “about 10” means between 9 and 11 inclusive of the endpoints 9 and 11.

Throughout this specification, unless the context dictates otherwise, the word “comprise,” or variations such as “comprises” or “comprising,” will be understood to imply the inclusion of a stated element, integer, step, or group of elements, integers, or steps, but not the exclusion of any other element, integer, step, or group of elements, integers, or steps.

As used herein, the term “germania” refers to germanium dioxide (GeO₂) and the term “silica” refers to silicon dioxide (SiO₂).

“Outside vapor deposition” (or OVD) is a process for forming glass wherein new glass is deposited in layers on top of or around a solid substrate. In OVD, the combustion process produces small, oxide glass particles along with some amount of un-combusted vapor. The vapor condenses around the particles, causing them to aggregate further and adhere to a substrate. In one aspect, the optical fiber preforms disclosed herein are fabricated using an OVD method.

As used herein, “core” refers to the innermost concentric layer of an optical fiber or optical fiber preform. In some aspects, the core of an optical fiber carries the light signals useful for communication.

As used herein, “cladding” refers to one or more layers deposited situated concentrically around the core and which traps light in the core. In some aspects, the cladding and core have different chemical compositions. In one aspect, the cladding consists of silica doped with another element. In an alternative aspect, the core consists of silica doped with another element. In one aspect, both the cladding and the core are doped with another element, which may be the same element or a different element. In one aspect, the dopant is germania. In some aspects, the core is formed before the cladding. In other aspects, the cladding is formed before the core.

In one aspect, as used herein, the term “soot” refers to SiO₂ or doped-SiO₂ particles, including those doped with GeO₂. In a further aspect, individual soot particles generally have a size of from about 0.01 μm to about 10 μm in diameter. In a further aspect, soot is laid down on a “bait rod,” which can be made from a ceramic material such as, for example, polycrystalline alumina. In one aspect, soot is produced by flame deposition of one or more precursors.

“Flame deposition” refers to reaction or decomposition of one or more deposition precursors in a flame to form soot. Flame deposition includes combustion, oxidation, and/or hydrolysis reactions.

“Precursor” refers to a chemical compound used as a starting material for flame deposition. A “silica precursor” is a precursor that includes silicon (Si) and forms silica soot or doped silica soot. A “germania precursor” or “germanium dioxide precursor” is a precursor that includes germanium (Ge) and forms germania (germanium oxide) soot or doped germania (doped germanium oxide) soot. An “organic precursor” is a precursor that includes carbon. An “organic silica precursor” is a silica precursor that includes carbon. An “organic germania (germanium dioxide) precursor is a germania (germanium dioxide) precursor that includes carbon. In some embodiments, an organic precursor, an organic silica precursor and an organic germania (germanium dioxide) precursor further includes oxygen.

“Soot preform” refers to a porous article made of soot particles, and the terms “porous soot” and “porous glass” can be used interchangeably.

“Core” or “core cane” refers to consolidated glass and may be formed from a silica glass or a doped silica glass, including a silica glass doped with GeO₂. “Cladding,” meanwhile is positioned around the core or core cane and can be formed from a silica glass or a doped silica glass, including a silica glass doped with GeO₂. In some aspects, core and cladding precursor structures can be formed separately and later assembled. In other aspects, the core can be deposited first (i.e., as soot) and the cladding deposited on the core. In still other aspects, the cladding can be formed first (i.e., as soot) and the core materials can be deposited or inserted inside the core. In one aspect, the core-cladding assembly can be further processed to form a fiber preform.

As used herein, “soot-to-glass transformation” refers to the process of going from a soot or porous state to a closed porosity state. In some aspects, the soot-to-glass transformation process may include a dehydration step, a doping step, and a sintering step. In a further aspect, these steps may be completed in any order (i.e., doping may occur before or after dehydration, etc.). In some aspects, a glass becomes void-free during the soot-to-glass transformation process.

An “optical fiber preform” or “preform” as used herein refers to a consolidated glass article from which an optical fiber can be drawn.

A “dehydration agent” or “drying agent” can be used to remove water from soot, a soot preform, or soot assemblies (e.g. a core-cladding assembly). In one aspect, the drying agent is a gas. In another aspect, the drying agent can be CCl₄, Cl₂, Br₂, SOCl₂, CO, SiCl₄, another gas, or a combination thereof.

“Refractive index” refers to the refractive index at a wavelength of 1550 nm, unless otherwise specified.

“Radial position”, “radius”, or the radial coordinate “r” refers to radial position relative to the centerline (r=0) of a soot preform, optical fiber preform, or optical fiber.

The “refractive index profile” is the relationship between refractive index or relative refractive index and radius.

“Relative refractive index,” as used herein, is defined as:

Δᵢ(rᵢ)%=100(nᵢ²−n_{ref}²)/2nᵢ²

where nᵢ is the refractive index at radial position rᵢ in the glass fiber, unless otherwise specified, and n_{ref} is the refractive index of pure silica glass, unless otherwise specified. Accordingly, as used herein, the relative refractive index percent is relative to pure silica glass, which has a refractive index of 1.444 at a wavelength of 1550 nm. As used herein, the relative refractive index is represented by Δ (or “delta”) or Δ% (or “delta %) and its values are given in units of “%”, unless otherwise specified. Relative refractive index may also be expressed as Δ(r) or Δ(r) %.

As used herein, “alkyl group” is a branched or unbranched saturated hydrocarbon group of 1 to 25 carbon atoms (C₁−C₂₅ group) , such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. In one aspect, the alkyl group is a branched or unbranched C₁ to C₁₀ group.

References in the specification and claims to atomic percentages of a particular element in a composition or article denote the molar relationship between the element or component and any other elements or components in the composition or article for which an atomic percentage is expressed. Thus, in a composition containing 2 atomic percent of component X and 5 atomic percent of component Y, X and Y are present at a molar ratio of 2:5, and are present in such a ratio regardless of whether additional components are used in the composition.

As used herein, a plurality of items, structural elements, compositional elements, and/or materials may be presented in a common list for convenience. However, these lists should be construed as though each member of the list is individually identified as a separate and unique member. Thus, no individual member of any such list should be construed as a de facto equivalent of any other member of the same list based solely on its presentation in a common group, without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an example, a numerical range of “about 1” to “about 5” should be interpreted to include not only the explicitly recited values of about 1 to about 5, but also to include individual values and sub-ranges within the indicated range. Thus, included in this numerical range are individual values such as 2, 3, and 4, the sub-ranges such as from 1-3, from 2-4, from 3-5, from about 1—about 3, from 1 to about 3, from about 1 to 3, etc., as well as 1, 2, 3, 4, and 5, individually. The same principle applies to ranges reciting only one numerical value as a minimum or maximum. The ranges should be interpreted as including endpoints (e.g., when a range of “from about 1 to 3” is recited, the range includes both of the endpoints 1 and 3 as well as the values in between). Furthermore, such an interpretation should apply regardless of the breadth or range of the characters being described.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc. of these materials are disclosed, that while specific reference to each various individual combination and permutation of these compounds may not be explicitly disclosed, each is specifically contemplated and described herein. For example, if an organic germania precursor is disclosed and discussed, and a number of different organic silica precursors are discussed, each and every combination of organic germania precursor and organic silica precursor that is possible is specifically contemplated unless specifically indicated to the contrary. For example, if a class of organic germania precursors A, B, and C are disclosed, as well as a class of organic silica precursors D, E, and F, and an example combination of A+D is disclosed, then even if each is not individually recited, each is individually and collectively contemplated. Thus, in this example, each of the combinations A+E, A+F, B+D, B+E, B+F, C+D, C+E, and C+F is specifically contemplated and should be considered from disclosure of A, B, ad C; D, E, and F; and the example combination A+D. Likewise, any subset or combination of these is also specifically contemplated and disclosed. Thus, for example, the sub-group of A+E, B+F, and C+E is specifically contemplated and should be considered from disclosure of A, B, and C; D, E, and F; and the example combination of A+D. This concept applies to all aspects of the disclosure including, but not limited to, steps in methods of making and using the disclosed compositions. Thus, if there are a variety of additional steps that can be performed with any specific embodiment or combination of embodiments of the disclosed methods, each such composition is specifically contemplated and should be considered disclosed.

### I. Method for Forming an Optical Fiber Preform

A. Substrate and First Composition

In one aspect, the methods disclosed herein require a substrate for deposition of soot particles. In another aspect, the substrate is a deposition surface such as, for example, a collection chamber, a rotating mandrel, or a bait rod. In a further aspect, when the substrate is a bait rod, it can be made from polycrystalline alumina. In another aspect, when the substrate is a bait rod, removal of the substrate provides a soot cladding monolith having an internal cavity. In a further aspect, a core cane can be inserted into the internal cavity to form a core-cladding assembly. In a still further aspect, a core-cladding assembly can be processed further to form a preform. In one aspect, a gap is present between the core and the cladding. In an alternative aspect, no gap is present between the core and the cladding.

In one aspect, the methods disclosed herein use a silica precursor. In one aspect, the silica precursor is an organic silica precursor. In a still further aspect, the silica precursor is a siloxane, a silicon alkoxide, an organosilane, a silicon alkylalkoxide, or a combination thereof. In an alternative aspect, the silica precursor is SiCl₄.

As used herein, a “siloxane” is any compound that includes the functional group Si—O—Si, including linear, branched and/or cyclic compounds. In a further aspect, the siloxane can be a polyalkysiloxane, a cyclic polyalkylsiloxane, or a combination thereof. Useful siloxanes according to the present disclosure include, but are not limited to, decamethylcyclopentasiloxane, hexamethylcyclotrisiloxane, hexamethyldisiloxane, octamethylcyclotetrasiloxane, polydimethylsiloxane, polymethylhydrosiloxane, tetrakis(trimethylsilyloxy)silane, and combinations thereof. In any of the above aspects, multiple silicon centers fulfilling the above requirements can be linked together in the same silica precursor by carbon atoms, oxygen atoms, alkylene groups, or the like.

As used herein, a “silicon alkoxide” has the following general structure:

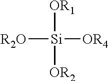

where R₁, R₂, R₃, and R₄ are, independently, selected from hydrogen or an alkyl group as defined herein. In one aspect, R₁-R₄ are the same alkyl group. In another aspect, R₁-R₄ are different groups with variations thereof (e.g., R₁-R₂ are the same alkyl group, R₁-R₃ are the same alkyl group, etc.). In one aspect, R₁, R₂, R₃, and/or R₄ are, independently, linear, branched, and cyclic alkyl groups, or can be C₁-C₁₀ linear, branched, and cyclic alkyl groups.

In another aspect, silicon alkoxide compounds useful herein include, but are not limited to, tetrabutoxysilane, tetraethoxysilane, and tetramethoxysilane. In any of the above aspects, at least one of R₁, R₂, R₃, and/or R₄ is a carbon-containing organic group and R₁, R₂, R₃, and/or R₄ can be the same or different. In any of the above aspects, multiple silicon centers fulfilling the above requirements can be linked together in the same silica precursor by carbon atoms, oxygen atoms, alkyl groups, or the like.

“Silane” is an inorganic compound with the chemical formula SiH₄. As used herein, an “organosilane” is a silane derivative with at least one direct bond between a silicon atom and a carbon atom (e.g., an alkyl group as defined herein). In some aspects, organosilanes useful herein have one, two, three, or four silicon-carbon direct bonds. Organosilanes useful herein include, but are not limited to, tris(trimethylsilyl)silane, triethylsilane, trimethylsilane, disilanes such as, for example, 1,1,2,2-tetramethyldisilane, pentamethyldisilane, and hexamethyldisilane, and combinations thereof, as well as compounds having the following general structure:

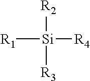

where R₁, R₂, R₃, and R₄ are, independently, hydrogen or an alkyl group, wherein at least one of R₁, R₂, R₃, and R₄ is an alkyl group. In any of the above aspects, at least one of R₁, R₂, R₃, and/or R₄ is an alkyl group and R₁, R₂, R₃, and/or R₄ can be the same or different. In any of the above aspects, multiple silicon centers fulfilling the above requirements can be linked together in the same silica precursor by carbon atoms, oxygen atoms, alkyl groups, or the like.

In another aspect, a “silicon alkylalkoxide” having the formula Si(OR′)ₓR″₄₋ₓ can be used herein, wherein R′ and R″ are an alkyl group and x<4. In other aspects, the silicon alkylalkoxide has the following general structure:

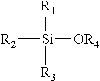

where R₁, R₂, and R₃, are, independently, hydrogen or an alkyl group and R₄ is an alkyl group. In any of the above aspects, R₁, R₂, R₃, and/or R₄ can be the same or different group. In any of the above aspects, multiple silicon centers fulfilling the above requirements can be linked together in the same silica precursor by carbon atoms, oxygen atoms, alkyl groups, or the like.

In another aspect, the silica precursor is an alkoxysilane (e.g., a trimethoxysilane or a triethoxysilane).

In one aspect, the silica precursor is a liquid at standard atmospheric pressure and room temperature. In another aspect, the silica precursor is octamethylcyclotetrasiloxane (OMCTS).

The methods disclosed herein uses a germanium dioxide (germania) precursor. In one aspect, the germanium dioxide precursor is an organic germanium dioxide precursor such as, for example, a germanium alkoxide, a germanium alkylalkoxide, a germanium alkyl, or a combination thereof. In an alternative aspect, the germanium dioxide precursor is GeCl₄.

As used herein, a “germanium alkoxide” has the following general structure:

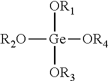

where R₁, R₂, R₃, and R₄ are, independently, selected from hydrogen or an alkyl group, where at least one of R₁-R₄ is an alkyl group. In one aspect, R₁, R₂, R₃, and R₄ are the same alkyl group. In another aspect, germanium alkoxide compounds useful herein include, but are not limited to, germanium methoxide, germanium ethoxide, germanium n-butoxide, germanium s-butoxide, germanium t-butoxide, germanium propoxide, germanium i-propoxide, and combinations thereof. That is, one or more of the groups OR₁, OR₂, OR₃, and OR₄ is methoxy, ethoxy, n-propoxy, i-propxy, n-butoxy, s-butoxy, or t-butoxide. In one aspect, additional oxygen atoms may be present in any of R₁, R₂, R₃, and/or R₄; thus, for example, further in this aspect, acetyloxy substituents may be bonded to the central germanium atom.

In another aspect, a “germanium alkylalkoxide” having the formula Ge(OR′)ₓR″₄₋ₓ can be used herein, wherein R′ and R″ are an alkyl group and x<4. In other aspects, a germanium alkylalkoxide has the following general structure:

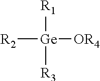

where R₁, R₂, and R₃ are, independently, selected from hydrogen or an alkyl group, wherein at least one of R₁, R₂, R₃ is an alkyl group, and R₄ is an alkyl group. In another aspect, additional oxygen atoms may be present in R₁, R₂, R₃, and/or R₄. Further in this aspect, OR₄ can be an acetyloxy group. In one aspect, (acetyloxy)triethylgermane is a germanium alkylalkoxide that is useful herein as a germanium dioxide precursor. In one aspect, R₁, R₂, R₃, and R₄ can be the same or different group.

As used herein, a “germanium alkyl” has the following general structure:

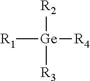

where R₁, R₂, R₃, and R₄ are, independently, selected from hydrogen or an alkyl group, wherein at least one of R₁-R₄ is an alkyl group. In one aspect, R₁, R₂, R₃, and/or R₄ can be the same or different group. In one aspect, germanium alkyl precursors useful herein include tetraethylgermane and tetramethylgermane.

In any of the above aspects, the germanium dioxide precursor can be any combination of germanium alkoxide, germanium alkylalkoxide, and/or germanium alkyl compounds as described above. In one aspect, the germanium dioxide precursor is a liquid at standard atmospheric pressure and room temperature.

In one aspect, the silica precursor is octamethylcyclotetrasiloxane (OMCTS) and the germanium dioxide precursor is germanium ethoxide.

In one aspect, the silica precursor and the germanium dioxide precursor can be mixed in proportion to provide a target GeO₂ dopant composition desired in the silica soot. In a further aspect, such a GeO₂ dopant concentration gives the glass, and preferably in the waveguiding core formed from the glass, a refractive index appropriate for guiding light when the GeO₂ doped glass is cladded with a glass having a lower refractive index. In some aspects, the cladding is a silica glass.

In another aspect, the molar ratio of silica precursor to germanium dioxide precursor in the first composition can be from about 1:1 to about 100:1, or can be about 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 25:1, 30:1, 35:1, 40:1, 45:1, 50:1, 60:1, 70:1, 80:1, 90:1, or 100:1, or a combination of any of the foregoing values, or a range encompassing any of the foregoing values (2:1 to 80:1, 10:1 to 40:1, etc.). In another aspect, the silica precursor and the germanium dioxide precursor are compatible at room temperature and under normal atmospheric conditions in all of the above proportions in that, when mixed, the resulting mixture does not show any evidence of a reaction taking place. In a further aspect, the silica precursor and the germanium dioxide precursor are compatible under the conditions of exposure to a conversion flame such as described below.

B. Methodology

In one aspect, the method for forming an optical fiber preform includes one or more of the following steps:
a. depositing particles including germanium dioxide and silica on a substrate, wherein the particles are produced by flame depositing a first composition containing a silica precursor and a germanium dioxide precursor on the substrate, wherein the first composition is deposited on the substrate at a temperature of less than or equal to 1250° C. to produce a soot preform coated on the substrate, and wherein at least one of the silica precursor or the germanium dioxide precursor is an organic precursor;
b. removing the substrate from the soot preform;
c. heating the soot preform under a first atmosphere that includes oxygen at a first temperature;
d. drying the soot preform after step (c) with a dehydration agent under a second atmosphere that includes oxygen;
e. heating the soot preform after step (d) under a third atmosphere that includes oxygen to form the optical fiber preform.

In certain aspects, prior to depositing particles of germanium dioxide and silica on the substrate (i.e., step (a)), the substrate is pre-heated. In one aspect, the substrate can be pre-heated with only a pre-mix flame (i.e. a flame produced from a combustion gas (e.g. fuel) and/or combustion supporting gas (e.g. O₂) without a precursor) at a temperature of from 300° C. to 1,300° C. In another aspect, the substrate is pre-heated at a temperature of from 400° C. to 1,100° C. using 1 to 20 passes of the pre-mix flame across the substrate at a traverse velocity. In another aspect, the substrate is pre-heated at a temperature of from 500° C. to 1,000° C. using 1 to 20 passes of the pre-mix flame across the substrate with a traverse velocity of 0.5 cm/s to 3.0 cm/s. In another aspect, the substrate is pre-heated at a temperature of from 600° C. to 900° C. using 1 to 20 passes of the pre-mix flame across the substrate with a traverse velocity of 0.5 cm/s to 3.0 cm/s and a return velocity of 40 cm/s to 100 cm/s. The traverse velocity represents the translation velocity as the soot is deposited on the substrate from the flame and the return velocity represents fast return of the burner at the end of a traverse pass to the starting position for initiation of the next pass. Not wishing to be bound by theory, the pre-heating of the substrate to a temperature above 500° C. prevents a spike in germania capture when compared to a relatively cold substrate. This feature is demonstrated in the Examples below.

In one aspect, in step (a), the first composition comprising the silica precursor and a germanium dioxide precursor is applied, in a flame deposition process, to the substrate at a substrate temperature of less than or equal to 1,250° C., less than or equal to 1,200° C., or less than or equal to 1,150° C., or less than or equal to 1,100° C., or less than or equal to 1,050° C., or less than or equal to 1,000° C., or between 500° C. and 1,250° C., or between 600° C. and 1,200° C., or between 700° C. and 1,150° C., or between 800° C. and 1,100° C. In another aspect, in step (a), the first composition comprising the silica precursor and a germanium dioxide precursor is applied, in a flame deposition process, to the substrate at a substrate temperature of 500° C., 550° C., 600° C., 650° C., 700° C., 750° C., 800° C., 850° C., 900° C., 950° C., or less than or equal to1,000° C., or a combination of any of the foregoing values, or a range encompassing any of the foregoing values (e.g., 500° C. to 900° C., 600° C. to 800° C., etc.).

In another aspect, the first composition is applied to the substrate in a flame deposition process at a rate of from 1×10⁻⁴ g/cm²/s to 1×10⁻² g/cm²/s, or is applied to the substrate in a flame deposition process at a rate of about 1×10⁻⁴ g/cm²/s, 5×10⁻⁴ g/cm²/s, 1×10⁻³ g/cm²/s, 5×10⁻³ g/cm²/s, or about 1×10⁻² g/cm²/s, or a combination of any of the foregoing values, or a range encompassing any of the foregoing values (e.g., 5×10⁻⁴ g/cm²/s to 5×10⁻³ g/cm²/s, 1×10⁻³ g/cm²/s to 1×10⁻² g/cm²/s, etc.).

In a further aspect, the first composition is applied to the substrate in a flame deposition process with 2 flame deposition burners, by 3 or more flame deposition burners, or by 4 or more flame deposition burners. In another aspect, the first composition is applied to the substrate by 2, 3, 4, 5, 6, 7, 8, 9, or 10 flame deposition burners.

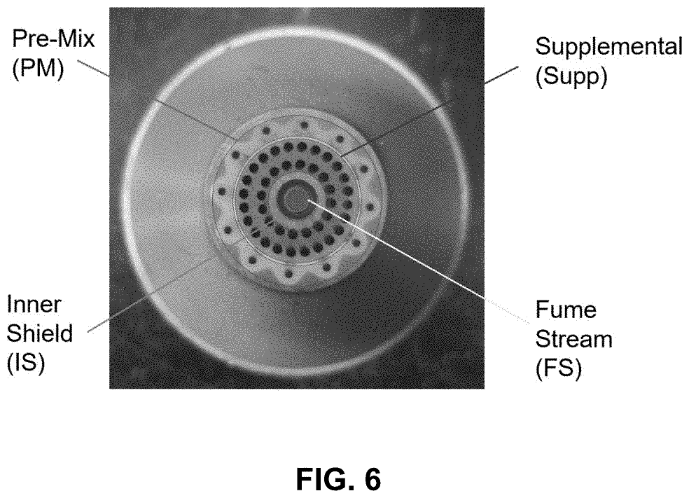

Flame deposition of the silica and germanium dioxide particles on the substrate can be performed by a number of techniques. In one aspect, the soot samples disclosed herein were fabricated using a single-spindle, single-burner, OVD lathe. In a further aspect, the spindle in the lathe is horizontal and the burner (see FIG. 6) traverses below it. In a further aspect, although successful samples were generated, other equipment designed specifically for core-making will create optimal conditions for germania capture.

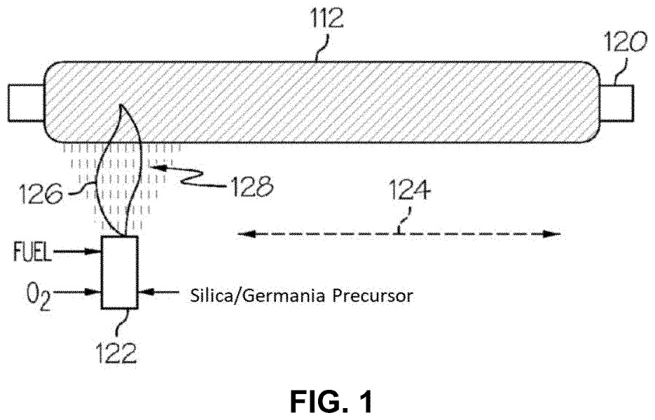

FIG. 1 illustrates deposition of a silica/germania soot layer 112 on bait rod 120. The silica/germania glass soot is formed by providing a vapor phase silica precursor and germanium dioxide precursor to a burner 122. In the embodiment of FIG. 1, the silica precursor and germanium dioxide precursor are supplied as a mixed stream to burner 122. The silica precursor and the germanium dioxide precursor are starting materials for a flame deposition process effected by burner 122 and the mixed stream of the silica precursor and germanium dioxide precursor is an example of a “first composition” as used herein. The gas-fed burner 122 is supplied with fuel, such as H2, CH₄, D₂ (deuterium), CD₄ or CO. Oxygen is also provided to burner 122 and the fuel and oxygen are combusted to create flame 126.

The vapor phase silica precursor and germanium dioxide precursor are reacted or decomposed in the flame 126 to produce silica/germania glass soot 128, which is deposited as soot layer 112 on bait rod 120. The bait rod 120 is preferably rotated to promote uniformity of composition. Soot layer 112 may constitute a single-layer soot cladding monolith or may constitute the innermost (smallest radius) layer of a multilayer soot cladding monolith. The flame 126 of the gas-fed burner 122 is traversed at a traverse velocity back and forth along the axial length of the bait rod 120 as indicated by arrow 124 as the bait rod is rotated thereby building up silica-based glass soot (e.g. silica glass soot doped with germania) and forming soot layer 112 on the bait rod 120.

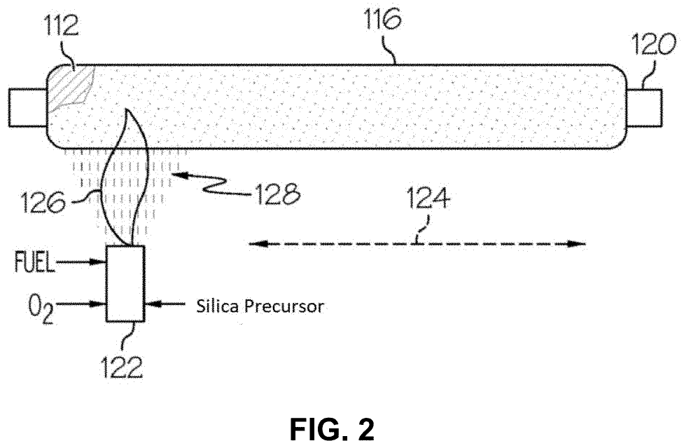

FIG. 2 depicts deposition of soot layer 116 on soot layer 112. Soot layer 116 may be formed in a similar manner as soot layer 112. For example, a vapor phase silica precursor may be supplied to the gas-fed burner 122 and reacted in the flame 126 to form silica-based glass soot which is deposited as soot layer 116 on soot layer 112 as the bait rod is rotated. In another aspect, a vapor phase silica precursor and germanium dioxide precursor may be supplied to the gas-fed burner 122 and reacted in the flame 126 to form silica/germania glass soot, which is deposited as soot layer 116 on soot layer 112 as the bait rod is rotated. Soot layer 116 may have the same, higher, or lower refractive index than soot layer 112. Soot layer 116 and soot layer 112 may both comprise germania-doped silica glass, where the concentration of germania differs in soot layer 116 and soot layer 112. FIGS. 1 and 2 show a single burner; however, the methods described herein can use a plurality of burners (i.e., two or more) as needed.

In another aspect, after step (a) and prior to step (b), a second composition comprising a silica precursor is applied to the soot preform. In one aspect, the second composition is the same as the first composition. In an alternative aspect, the second composition is different from the first composition.

In one aspect, silica is deposited on the bait rod before germania is deposited. Further in this aspect, earlier passes (traversals) with silica may lead to more uniform radial deposition of silica. In another aspect, the method disclosed herein provides for germania capture at lower preform temperatures. In one aspect, and without wishing to be bound by theory, pre-deposition of silica before germania allows for a lower preform temperatures and/or lower soot density that, in turn, enable increased germania capture. In another aspect, when the soot preform or flame temperature is cooler, soot density is lower. In still another aspect, increasing traverse velocity can increase germania capture. In yet another aspect, other factors also increase germania capture including, but not limited to, rotation rate in rpm of the soot preform, increasing the flow rate of inner shield nitrogen in burner 122, and lowering precursor delivery rate to burner 122.

In one aspect, other parameters can be varied during the flame deposition of the silica and germanium dioxide particles to increase germania capture and/or uniformity of germania deposition. In one aspect, traverse velocity can be varied. In another aspect, the flow rate of inner shield nitrogen to burner 122 can be varied, for example, from about 3.5 slpm to 6.5 slpm, or can be about 3.5 slpm, 4 slpm, 4.5 slpm, 5 slpm, 5.5 slpm, 6 slpm, or about 6.5 slpm, or a combination of any of the foregoing values, or a range encompassing any of the foregoing values (e.g., about 4 slpm to about 6 slpm, 3.5 slpm to about 5 slpm, etc.).

In one aspect, reducing precursor delivery rate (that is, the delivery rate of the first composition to burner 122) can lead to a cooler flame 126, thus reducing vaporization of GeO₂ into GeO and increasing GeO₂ capture. In one aspect, precursor delivery rate can be from about 6 g/min to 7.6 g/min, or can be 6 g/min, 6.1 g/min, 6.2 g/min, 6.3 g/min, 6.4 g/min, 6.5 g/min, 6.6 g/min, 6.7 g/min, 6.8 g/min, 6.9 g/min, 7 g/min, 7.1 g/min, 7.2 g/min, 7.3 g/min, 7.4 g/min, 7.5 g/min, or about 7.6 g/min, or a combination of any of the foregoing values, or a range encompassing any of the foregoing values (e.g., 6.1 g/min to 7.2 g/min, 6.6 g/min to 7.5 g/min, etc.).

In another aspect, flame stoichiometry can be varied in order to modify oxidation of germania to control germania capture. In one aspect, increasing fume stream oxygen may decrease germania capture. In one aspect, when the silica precursor is OMCTS, adding fume stream oxygen increases soot density. In a further aspect, increased fume stream oxygen can lead to a slight decrease in germania retained after consolidation. In some aspects, oxygen has a minimum concentration that must be present as it is required for combustion of OMCTS. In another aspect, increasing the flow rate of inner shield nitrogen may further increase germania capture. In one aspect, various factors may affect density of the soot preform, in turn affecting germania capture. In a further aspect, these factors can include, but are not limited to: reducing delivery rate of precursors, increasing rotation rate of lathe, increased traverse velocity, increasing the flow rate inner shield nitrogen, and increasing the flow rate of fume stream oxygen. In yet another aspect, different burner designs also affect germanium deposition.

In one aspect, process conditions used to form the different layers of a multilayer soot cladding and/or a core cane and cladding can be the same or different. In one aspect, variables such as, for example, flame temperature, flow rates of precursors for silica precursors or dopants, traversal velocity of burner(s) along the length of the substrate, and rotation speed of the substrate can be varied according to the desired properties of the final soot preform. In one aspect, variation of these process conditions can control the deposition rate of soot and density of soot in the as-deposited state. In one aspect, higher flame temperatures can promote higher soot densities. In an alternative aspect, lower flame temperatures lower the density of as-deposited soot. In still another aspect, density of the soot layer can be influenced by the delivery of the silica and germanium dioxide precursors to the burner(s). In still another aspect, the density of the soot layer can be influenced by changing the rate of rotation of the substrate, where an increase in rate of rotation leads to a decreased density and a decrease in rate of rotation leads to an increased soot density. In still another aspect, different layers of soot (e.g., multiple layers of cladding or core and cladding) can have different densities.

In one aspect, the traverse velocity during step (a) can be modified in order to increase the amount of germania that is deposited on the substrate. In one aspect, the traverse velocity is from 0.5 cm/s to 5 cm/s, or is 0.5 cm/s, 1 cm/s, 1.5 cm/s, 1.5 cm/s, 2 cm/s, 2.5 cm/s, 3 cm/s, 3.5 cm/s, 4 cm/s, 4.5 cm/s, or 5 cm/s, where any value can be the a lower and upper end-point of a range (e.g., 0.5 cm/s to 3 cm/s, 2 cm/s to 5 cm/s, etc.).

In another aspect, the soot preform can be cooled prior to each subsequent deposition of particles (e.g., silica particles with or without germania particles). Not wishing to be bound by theory, cooling the soot preform can increase the amount of germania that is deposited on the soot preform. Moreover, the germania is more evenly distributed throughout the soot preform. In one aspect, the soot preform is cooled to 200° C. to 800° C., or 200° C., 250° C., 300° C., 350° C., 400° C., 450° C., 500° C., 550° C., 600° C., 650° C., 700° C., 750° C., or 800° C., where any value can be a lower and upper end-point of a range (e.g., 250° C. to 700° C., etc.).

After step (a), the substrate is removed from the soot preform in step (b), and the soot preform is subsequently heated under a first atmosphere comprising oxygen at a first temperature (referred to herein as step (c)). In one aspect, in step (c), heating occurs in a first atmosphere having from about 0.5 vol % to about 10 vol % oxygen, or about 0.5 vol %, 1 vol %, 1.5 vol %, 2 vol %, 2.5 vol %, 3 vol %, 3.5 vol %, 4 vol %, 4.5 vol %, 5 vol %, 5.5 vol %, 6 vol %, 6.5 vol %, 7 vol %, 7.5 vol %, 8 vol %, 8.5 vol %, 9 vol %, 9.5 vol %, or about 10 vol % oxygen, or a combination of any of the foregoing values, or a range encompassing any of the foregoing values (e.g., 1 vol % to 9 vol %, 3 vol % to 7 vol %, etc.).

In one aspect, the first atmosphere includes oxygen and an inert gas such as, for example, helium, nitrogen, argon, or any combination thereof. In another aspect, in step (c), the atmosphere has from about 90 vol % to about 99.5 vol % inert gas, or about 90 vol %, 90.5 vol %, 91 vol %, 91.5 vol %, 92 vol %, 92.5 vol %, 93 vol %, 93.5 vol %, 94 vol %, 94.5 vol %, 95 vol %, 95.5 vol %, 96 vol %, 96.5 vol %, 97 vol %, 97.5 vol %, 98 vol %, 98.5 vol %, 99 vol %, or about 99.5 vol % inert gas, or a combination of any of the foregoing values, or a range encompassing any of the foregoing values (e.g., 91 vol % to 98 vol %, 92 vol % to 97 vol %, etc.). In a further aspect, in step (c), heating is conducted at a temperature of less than or equal to 1000° C. In another aspect, heating is conducted at a temperature of about 600° C., 650° C., 700° C., 750° C., 800° C., 850° C., 900° C., 950° C., or 1000° C., or a combination of any of the foregoing values, or a range encompassing any of the foregoing values (e.g., 750° C. to 900° C., 700° C. to 800° C., etc.).

In one aspect, the methods disclosed herein including a drying step (referred to herein as step (d)). In another aspect, the soot preform resulting from step (c) is dried in step (d) with a dehydration agent under a second atmosphere comprising oxygen. In one aspect, the dehydration agent can be CCl₄, Cl₂, Br₂, SOCl₂, CO, SiCl₄, or any combination thereof. In one aspect, at the temperature at which the drying step (d) occurs, the dehydration agent is a gas. In another aspect, the dehydration agent has a concentration in the second atmosphere of 1 vol %, 1.5 vol %, 2 vol %, 2.5 vol %, 3 vol %, 3.5 vol %, 4 vol %, 4.5 vol %, 5 vol %, 5.5 vol %, 6 vol %, 6.5 vol %, 7 vol %, 7.5 vol %, 8 vol %, 8.5 vol %, 9 vol %, 9.5 vol %, or 10 vol %, or a combination of any of the foregoing values, or a range encompassing any of the foregoing values (e.g., 1.5 vol % to 8 vol %, 2 vol % to 7 vol %, etc.). In another aspect, the dehydration agent comprises Cl2 and has a concentration of about 5 vol % in the second atmosphere.

In another aspect, in addition to the dehydration agent, the second atmosphere surrounding the soot preform during the drying step (d) includes oxygen. In one aspect, the oxygen is present in the second atmosphere at a concentration of greater than or equal to 0.5 vol %. In another aspect, the oxygen is present in the second atmosphere at a concentration of from or about 0.5 vol %, 1 vol %, 1.5 vol %, 2 vol %, 2.5 vol %, 3 vol %, 3.5 vol %, 4 vol %, 4.5 vol %, 5 vol %, 5.5 vol %, 6 vol %, 6.5 vol %, 7 vol %, 7.5 vol %, 8 vol %, 8.5 vol %, 9 vol %, 9.5 vol %, or about 10 vol % oxygen, or a combination of any of the foregoing values, or a range encompassing any of the foregoing values (e.g., 1 vol % to 9 vol %, 3 vol % to 7 vol %, etc.). In another aspect, the second atmosphere surrounding the soot preform during the drying step (d) includes an inert gas such as, for example, nitrogen, helium, argon, or any mixture thereof having a concentration of from about 90 vol % to about 99.5 vol %, or about 90 vol %, 90.5 vol %, 91 vol %, 91.5 vol %, 92 vol %, 92.5 vol %, 93 vol %, 93.5 vol %, 94 vol %, 94.5 vol %, 95 vol %, 95.5 vol %, 96 vol %, 96.5 vol %, 97 vol %, 97.5 vol %, 98 vol %, 98.5 vol %, 99 vol %, or about 99.5 vol % inert gas, or a combination of any of the foregoing values, or a range encompassing any of the foregoing values (e.g., 91 vol % to 98 vol %, 92 vol % to 97 vol %, etc.).

In a further aspect, the soot preform is a soot cladding and dehydration can occur before or after the core cane and soot cladding are assembled to form a core-cladding assembly. In one aspect, the soot preform is heated in the presence of the dehydration agent in the drying step (d) at a temperature of less than or equal to about 1250° C. In another aspect, the drying step (d) can be conducted at an elevated temperature of from about 600° C. to about 1250° C., or at about 600° C., 650° C., 700° C., 750° C., 800° C., 850° C., 900° C., 950° C., 1,000 ° C., 1050° C., 1,100° C., 1,150° C., 1,200° C., or about 1,250° C., or a combination of any of the foregoing, or a range encompassing any of the foregoing values (e.g., 700° C. to 1,200° C., 1,000° C. to 1,200° C., etc.). In still another aspect, the dehydration agent can be removed from the environment surrounding the core-cladding assembly or soot preform upon conclusion of the drying step (d).

In another aspect, at any point in the process of making the optical fiber preform, a sintering step may be performed. In one aspect, sintering occurs after the drying step (d). In a further aspect, sintering can have several effects including, but not limited to, consolidation of the soot cladding, soot preform and/or the core, fusing the soot cladding or soot preform with the core to form a consolidated fiber preform, and the like.

After the drying step (d), the soot preform is heated under a third atmosphere comprising oxygen to produce the optical preform (referred to herein as step (e)). In one aspect, the soot preform (or soot cladding or core-cladding assembly) is heated at a temperature of greater than or equal to 1,400° C. for a period of time greater than or equal to 30 minutes. In another aspect, the soot preform (or soot cladding or core-cladding assembly) is heated for a period of from 30 minutes to 5 hours, or for about 30 minutes, about 1 hour, about 1.5 hours, about 2 hours, about 2.5 hours, about 3 hours, about 3.5 hours, about 4 hours, about 4.5 hours, or about 5 hours, or a combination of any of the foregoing values, or a range encompassing any of the foregoing values (about 1 hour to about 4 hours, about hours to about 5 hours, etc.). In another aspect, during step (e), the soot preform (or soot cladding or core-cladding assembly) is heated at a temperature of from about 1,400° C. to about 1,525° C., or at about 1,400° C., 1,425 ° C., 1,450° C., 1,475° C., 1,500° C., or about 1,525° C. or a combination of any of the foregoing values, or a range encompassing any of the foregoing values (e.g., 1,425° C. to 1,500° C., 1,400° C. to 1,525° C., etc.).

In another aspect, during step (e), the third atmosphere surrounding the soot preform (or soot cladding or core-cladding assembly) includes oxygen at a concentration of greater than or equal to 0.1 vol %, or of from 0.1 vol % to 10 vol %. In another aspect, the oxygen concentration is about 0.1 vol %, 0.5 vol %, 1 vol %, 1.5 vol %, 2 vol %, 2.5 vol %, 3 vol %, 3.5 vol %, 4 vol %, 4.5 vol %, 5 vol %, 5.5 vol %, 6 vol %, 6.5 vol %, 7 vol %, 7.5 vol %, 8 vol %, 8.5 vol %, 9 vol %, 9.5 vol %, or about 10 vol % oxygen, or a combination of any of the foregoing values, or a range encompassing any of the foregoing values (e.g., 0.5 vol % to 9 vol %, 3 vol % to 7 vol %, etc.). In another aspect, the third atmosphere comprises an inert gas such as, for example, nitrogen, argon, helium, or any combination thereof having a concentration of from about 90 vol %, 90.5 vol %, 91 vol %, 91.5 vol %, 92 vol %, 92.5 vol %, 93 vol %, 93.5 vol %, 94 vol %, 94.5 vol %, 95 vol %, 95.5 vol %, 96 vol %, 96.5 vol %, 97 vol %, 97.5 vol %, 98 vol %, 98.5 vol %, 99 vol %, about 99.5 vol %, or about 99.9 vol % inert gas, or a combination of any of the foregoing values, or a range encompassing any of the foregoing values (e.g., 91 vol % to 98 vol %, 92 vol % to 97 vol %, etc.).

### II. Optical Fiber Preform Properties and Characteristics

The preforms produced herein possess several physical and chemical features that make them desirable in the manufacture of optical fibers. The methods described herein permit the manufacturing of large optical fiber preforms. In one aspect, the optical fiber preform has a weight of greater than or equal to 6 kg, greater than or equal to 9 kg, greater than or equal to 20 kg, greater than or equal to 40 kg. In another aspect, the optical fiber preform has a weight of from about 6 kg to about 80 kg. Further in this aspect, the optical fiber preform has a weight of about 6 kg, 9 kg, 15 kg, 20 kg, 25 kg, 30 kg, 35 kg, 40 kg, 45 kg, 50 kg, 55 kg, 60 kg, 65 kg, 70 kg, 75 kg, 80 kg, or a combination of any of the foregoing values, or a range encompassing any of the foregoing values (e.g., 20 kg to 60 kg, 35 kg to 45 kg, etc.).

In another aspect, the optical fiber preform has a thickness of from about 2 cm to about 12 cm, or of about 2 cm, 3 cm, 4 cm, 5 cm, 6 cm, 7 cm, 8 cm, 9 cm, 10 cm, 11 cm, or about 12 cm, or a combination of any of the foregoing values, or a range encompassing any of the foregoing values (e.g., 3 cm to 11 cm, 4 cm to 8 cm, etc.).

In another aspect, the preforms described herein high amounts of germania evenly distributed in specific regions of the preform. In one aspect, the preform has germania in the amount of from 6 wt % to 20 wt %, or 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, or a combination of any of the foregoing values, or a range encompassing any of the foregoing values (e.g., 5 wt % to 15 wt %, 10 wt % to 12 wt %, etc.).

In one aspect, the fiber preform produced herein includes two or more regions that differ in refractive index. In one aspect, core cane and soot cladding monolith may each consist of one or more layers, where the different layers differ in refractive index. Fibers drawn from the preform will have core and cladding regions having refractive indices controlled by or corresponding to the different regions in the preform.

III. Optical Fiber Formed from the Optical Fiber Preforms Described Herein

In one aspect, provided herein is an optical fiber formed from the optical fiber preforms disclosed herein. In one aspect, the optical fiber is formed by drawing the optical fiber preforms disclosed herein using techniques and apparatus known in the art.

### EXAMPLES

The following examples are put forth so as to provide those of ordinary skill in the art with a complete disclosure and description of how the compounds, compositions, and methods described and claimed herein are made and evaluated, and are intended to be purely exemplary and are not intended to limit the scope of the discovery disclosed herein. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Numerous variations and combinations of reaction conditions (e.g., component concentrations, desired solvents, solvent mixtures, temperatures, pressures, and other reaction ranges and conditions) can be used to optimize the product purity and yield obtained from the described process. Only reasonable and routine experimentation will be required to optimize such process conditions.

### Example 1

### General Process

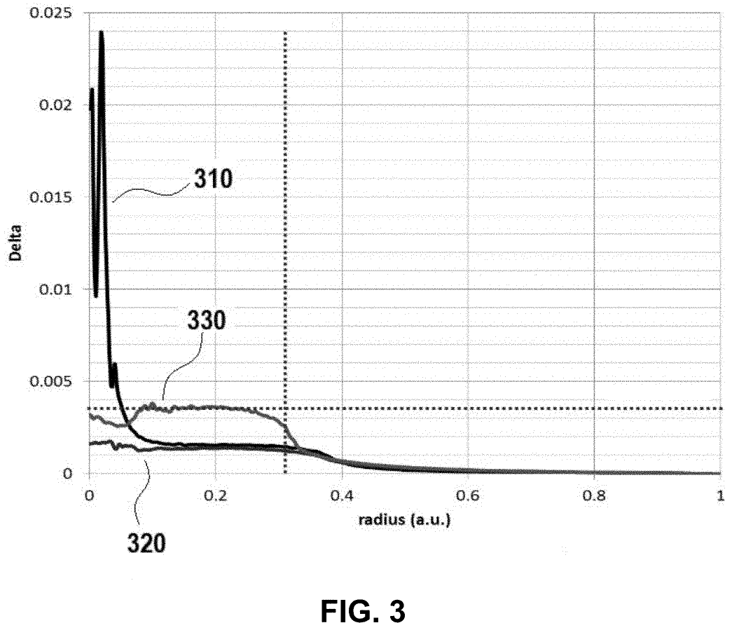

The examples that follow describe the preparation and properties of soot preforms, optical fiber preforms made from the soot preforms, and optical fibers drawn from the optical fiber preforms. The soot preforms consisted of a core surrounded by a cladding and were made in an OVD process with a single burner. The core consisted of silica glass doped with germanium dioxide and was made by delivering a mixed feedstock stream to the burner and depositing germania-doped silica soot formed from the mixed feedstock on a bait rod. The mixed feedstock stream for the core portion of the soot preform consisted of 75 wt % octamethylcyclotetrasiloxane (OMCTS) (an organic silica precursor) and 25 wt % tetraethoxygermane (TEOG) (an organic germania precursor also known as germanium tetraethoxide) in vapor phase form. Assuming 100% capture of SiO₂ and GeO₂, the resulting soot layer would contain 14.6 wt % germania. The cladding portion of the soot preform consisted of undoped silica and was formed by depositing silica soot formed from OMCTS on the core portion of the soot preform. The laydown time for the core portion of the soot preform was 90 min and the laydown time of the cladding portion of the soot preform was 4-7 hours (depending on core capture and the desired core/clad ratio of the soot preform). Prior to each laydown, the ceramic bait rod was heated with only the pre-mix flame (CH₄/O₂), using 10 passes with a 1.5 cm/s traverse velocity and a 63 cm/s return velocity. The purpose of this preheating was to prevent a spike in germania capture, an effect routinely observed when depositing germania-doped silica directly on unheated bait rods. It was discovered that in addition to pre-heating the bait rod with the pre-mix flame, additional pre-passes with the pre-mix flame and OMCTS to form a layer silica on the bait rod were required to prevent a spike in germania concentration at the surface of the bait rod (see discussion of FIG. 3 below). OVD lathe conditions were altered to control the temperature of the soot preform during deposition to increase germania capture and provide more uniform doping of germania throughout the thickness of the core. In particular, it was observed that if the temperature of the soot preform was higher than about 1200° C., germania capture in the core portion of the preform decreased and non-uniformities in germania concentration were present. Through additional experiments described below, other parameters were modified to increase germania capture efficiency further. A York refractive index profile of 0.055% Δ equals 1 wt % germanium, and the experiments described below were conducted with the goal of a target 0.0033% Δ, or about 6 wt % germanium.

### Example 2

### Uniformity of Deposition and Levels of GeO₂

FIG. 3 shows the refractive index profile of soot preforms formed under different deposition conditions after consolidation. The core portion of the soot preforms was formed using the mixed feedstock stream referred to in Example 1 and OMCTS was used to form the cladding portion of the soot preform. The refractive index profile provides an indication of the uniformity of the distribution of germania in the core portion of the soot preform under the different deposition conditions. The radius is expressed in arbitrary units (a.u.) and represents radial position relative to the outer radius of the preform. That is, an arbitrary unit of 1 corresponds to the outer radius of the preform.

Trace 310 shows deposition onto a bait rod that had been pre-heated with the pre-mix flame without completing any pre-passes of silica. The conditions of pre-heating were as noted in Example 1. As seen in trace 310, the concentration profile of germania in the core was irregular and showed sharp, spike-like features. Such severe non-uniformity in germania concentration is unacceptable for practical applications.

To improve the uniformity of germania in the core region of the soot preform, the bait rod was treated with pre-passes of silica following pre-heating with the pre-mix flame. To complete the pre-passes of silica, OMCTS was introduced to the burner along with the pre-mix gases and the burner was traversed along the bait rod for several passes to form a thin layer of silica on the bait rod before depositing germania-doped silica. Trace 320 shows that the uniformity of germania was significantly improved when the bait rod was treated with pre-passes of silica. The relatively low concentration of germania observed in Trace 320 is a consequence of the high surface temperature of the soot preform at the time of deposition of the germania-doped silica. To increase the germania concentration, the surface temperature of the soot preform was lowered by varying the ratio of OMCTS and TEOG in the mixed feedstock. Trace 330 shows the result. The soot preform depicted by Trace 330 included the pre-heating and pre-passes described for Trace 320. The lower surface temperature of the soot preform resulted in a higher germania concentration in the core portion of the soot preform. The uniformity of the concentration of germania was retained.

In some embodiments, the surface temperature of the soot preform at the time of depositing germania-doped silica is less than 1200° C., or less than 1000° C., or less than 800° C., or greater than 500° C., or greater than 700° C., or in the range from 500° C. to 1200° C., or in the range from 700° C. to 1200° C., or in the range from 700° C. to 1100° C., or in the range from 700° C. to 1000° C.

### Example 3

### Electron Microprobe Analysis (EMPA)

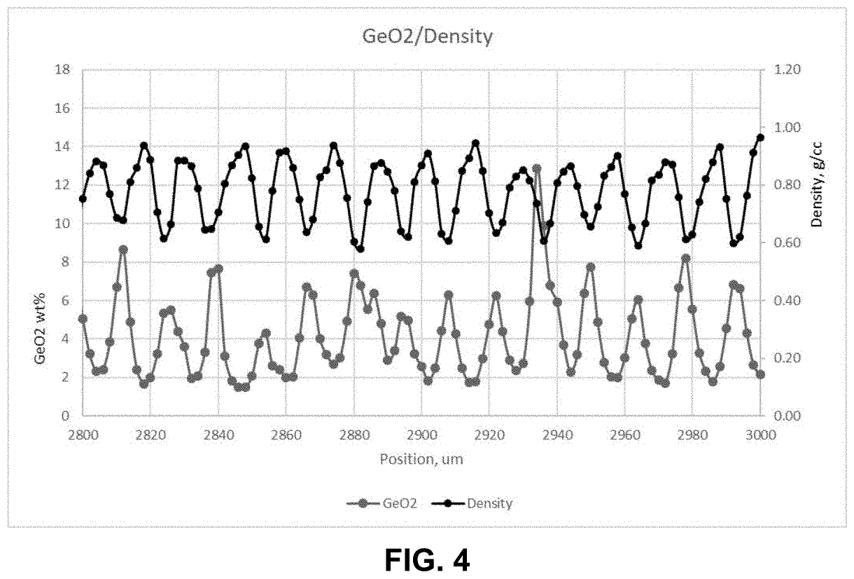

Electron microprobe analysis of soot preforms showed distinct striations of germania and density radially in the soot preform before consolidation. A portion of this data can be seen in FIG. 4, which shows variations in the density (top curve, right ordinate axis) and germania concentration (lower curve, left ordinate axis) of germania-doped silica soot prepared from the mixed feedstock stream described in Example 1 as a function of radial position within the soot preform (where a radial position of zero corresponds to the central axis of the soot preform and where only a selected, representative portion of radial position is illustrated.). The data shown in FIG. 4 demonstrates that the surface temperature of the soot preform at the time of deposition is an important factor in the germania-capture of germania-doped silica made using an organic precursor.

### Example 4

### Impact of Traverse Speed and Flow Conditions on Soot Density

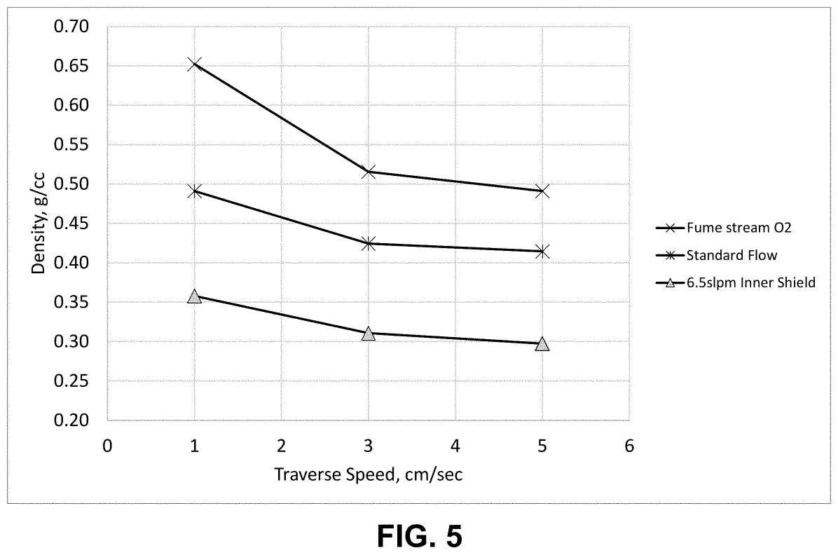

Soot samples with only OMCTS and absent any germania precursor were deposited, with the mass and diameter of soot recorded and used to calculate the density of the soot. FIG. 5 shows three different flows at three traverse speeds. FIG. 6 is a diagram explaining nomenclature in the titles of the data sets used herein. Flow conditions used to form soot preforms for optical fiber preform samples A-G are shown in Table 1 below (where PM means pre-mix, Supp means supplemental, and IS means inner shield):

TABLE 1
Gas and Precursor Flow Recipes (Flow Rates in sccm)

| | | PM | PM | Supp | Supp | Fume | Fume | IS | OMCTS/TEOG |
|---|---|---|---|---|---|---|---|---|---|
| Descriptor | Sample | CH₄ | O₂ | O₂ | CH₄ | O₂ | N₂ | N₂ | Rate (g/min) |
| Standard | A | 2960 | 2900 | 10000 | 0 | 0 | 6500 | 3500 | 7.6 |
| Flow | B | | | | | | | | |
| | C | | | | | | | | |
| | D | | | | | | | | |
| Fume | E | 2960 | 2900 | 10000 | 0 | 1500 | 5000 | 3500 | 7.6 |
| Stream O₂ | | | | | | | | | |
| High Inner | G | 2960 | 2900 | 10000 | 0 | 0 | 6500 | 6500 | 7.6 |
| Shield N₂ | | | | | | | | | |
| Low | F | 1222 | 1000 | 6800 | 0 | 1250 | 1800 | 2500 | 6 |
| Precursor | | | | | | | | | |
| Flow | | | | | | | | | |

The germania-doped silica soot preforms formed from the flow conditions listed in Table 1 were treated according to the methods described herein to form optical fiber preform samples A-G. More specifically, each soot preform was placed in a furnace at 1,200° C. and the preform was heated for 60 minutes in a furnace environment while flowing 2 slpm of oxygen and 20 slpm of helium (step (c)). The preform was subsequently dried by treating with a dehydration agent (chlorine) for a period of 130 minutes by flowing 0.94 slpm chlorine (Cl₂), 2 slpm oxygen and 20 slpm helium (step (d)). After the flow of chlorine to the furnace was turned off, the preform was kept in the furnace for 45 minutes while flowing 2 slpm of oxygen and 20 slpm of helium (step (e)). The preform was then sintered to a fully densified glass state by traversing it through a furnace hot zone with peak temperature of 1490° C. and flowing 10 slpm helium through the furnace. A fully densified germania-doped silica preform was obtained for each soot preform prepared under the flow conditions listed in Table 1 (corresponding to optical fiber preform samples A-F as indicated in Table 1).

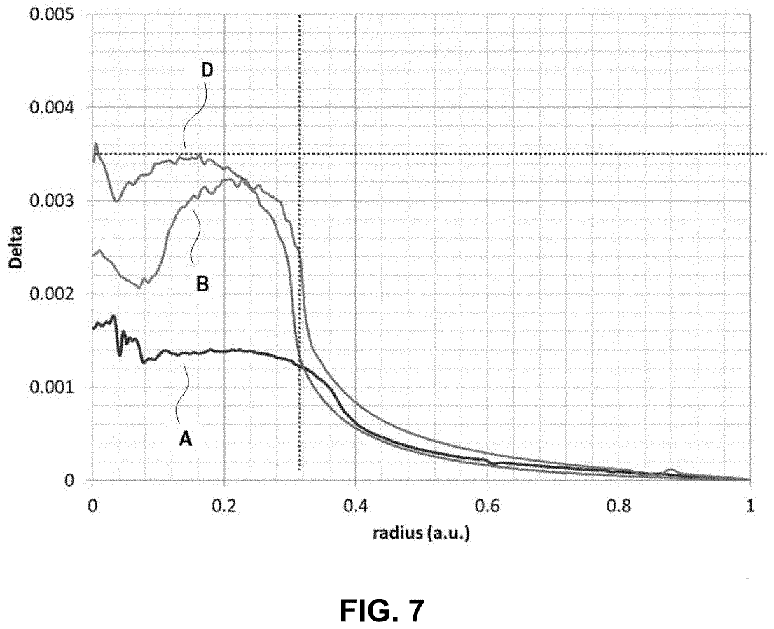

FIG. 7 compares the relative refractive index of optical fiber preform samples A, B, and D. As noted in Table 1, the flow conditions used to prepare optical fiber preform samples A, B, and D were identical. Different flame traversal velocities, however, were used in the preparation of optical fiber preform samples A, B, and D. Flame traversal velocities of 1.38 cm/s, 3.0 cm/s, and 4.0 cm/s were used in the preparation of the soot preforms used to form optical fiber preform samples A, B, and D, respectively. A faster flame traversal velocity leads to a shorter time of interaction of the flame with the soot preform and as a result, the surface temperature of the preform at the time of deposition is lower and the germania capture is higher. As shown in FIG. 7, optical fiber preform sample D has a higher core refractive index than optical fiber preform sample B, which has a higher core refractive index than optical fiber preform sample A. These results are consistent with higher germania capture in optical fiber preform sample D relative to optical fiber preform sample B, which has a higher germania capture than optical fiber preform sample A.

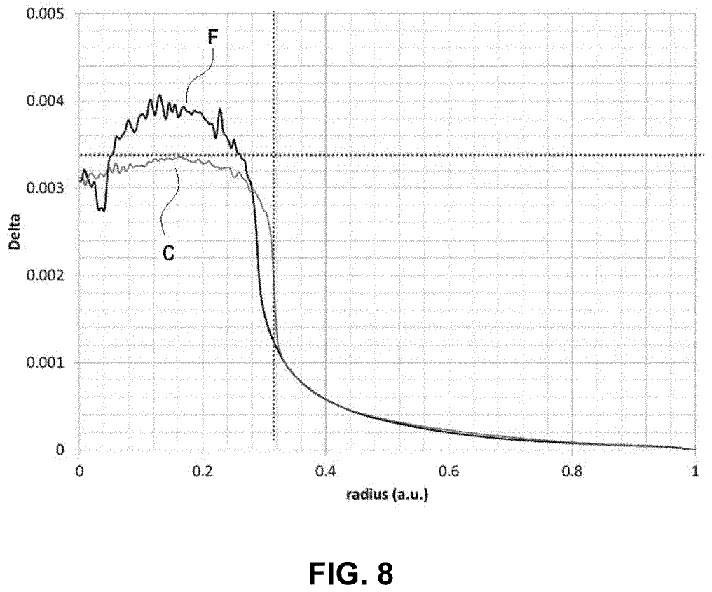

FIG. 8 compares the relative refractive index of optical fiber preform samples C and F. Sample F exhibits a higher relative refractive index in the core region (the region corresponding to radial positions below the target radius depicted in FIG. 8) than sample C. The main difference in flow condition for samples C and F is the flow rate of the mixed stream feedstock containing the organic silicon precursor and the organic germanium precursor. The feedstock flowrate for sample C was 7.6 g/min, while the feedstock flow rate for sample F was 6 g/min. A lower feedstock flowrate is expected to produce a cooler flame (due to a reduction in heat produced from reaction of the precursors). The cooler flame leads to a lower surface temperature of the soot preform during deposition and to higher germania capture for sample F relative to sample C.

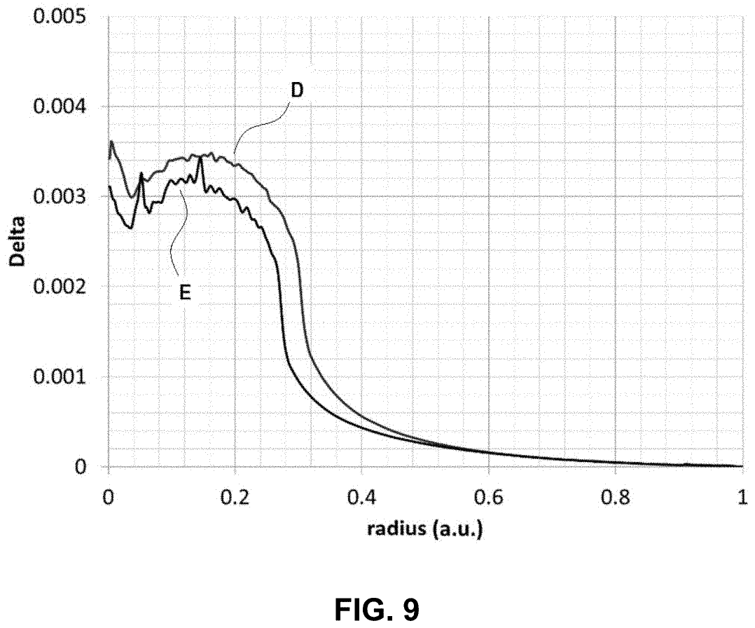

The effect of flame stoichiometry on germania capture was also evaluated. As seen in FIG. 5 in the all OMCTS test case, adding fume stream O₂ increases soot density. FIG. 9 shows a comparison of the relative refractive index profiles of optical fiber preform samples D and E. Optical fiber preform sample D exhibits a higher core relative refractive index than optical fiber preform sample E, indicating that the concentration of germania is higher in the core of optical fiber preform sample D than in the core of optical fiber preform sample E. Table 1 indicates that the main difference in flow condition for optical fiber preform samples D and E is the flow rate of the fume O₂ stream to the burner (1500 slpm (sample E) vs. 0 slpm (sample D)). The presence of O₂ in the fume stream leads to a hotter flame, a hotter surface temperature of the soot preform and a consequent reduction in germania capture.

### Example 5

### Fiber Properties

The processes and conditions described above were used to deposit germania-doped silica soot to form soot preforms that were converted to optical fiber preforms from which optical fiber was drawn. This section describes properties of optical fibers drawn from optical fiber preforms made in accordance with the present method. All fiber discussed and evaluated below was drawn at 1 m/s at lengths of 1500-2000 meters from an optical fiber preform corresponding to optical fiber preform sample F described above.

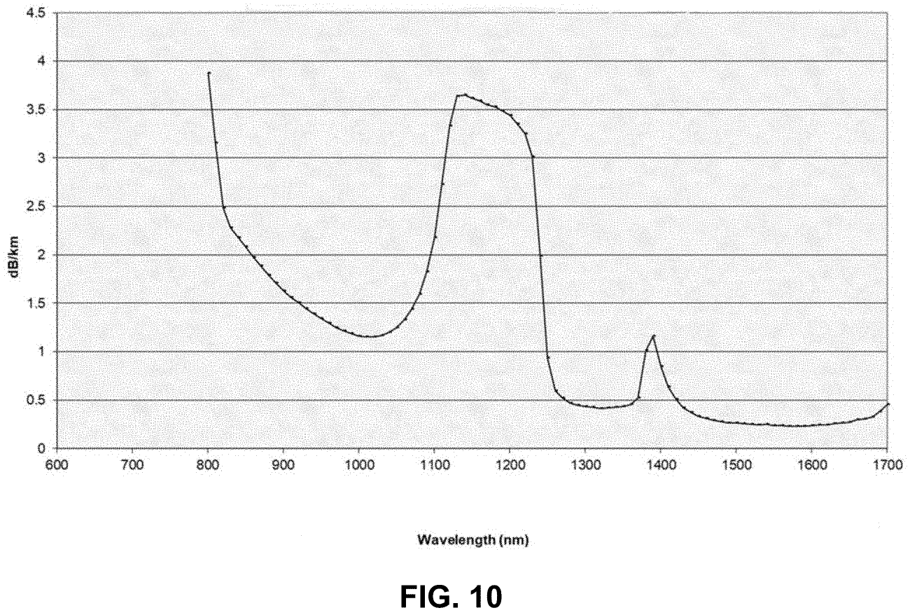

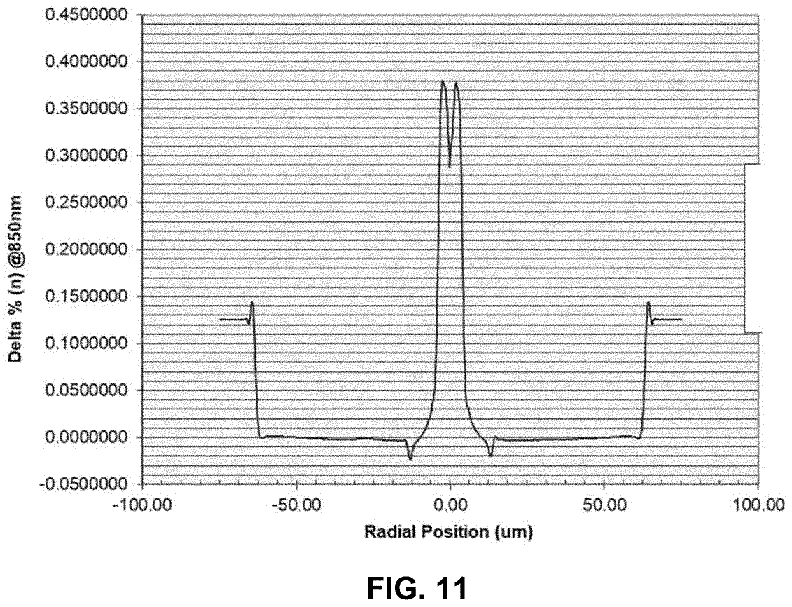

FIG. 10 shows attenuation (dB/km) as a function of wavelength (nm) for a representative optical fiber. The fiber exhibits low attenuation loss (0.239 dB/km at 1550 nm and 0.427 dB/km at 1310 nm). The dominant source of loss is attributed to impurities from external contamination known to be present in the experimental lathe used to prepare the soot preform. No meaningful attenuation was attributed to the organic precursors used to form the soot preform. FIG. 11 is a refractive index profile (at a wavelength of 850 nm) for the fiber with the spectrum shown in FIG. 10. The peak relative refractive index (0.37995% Δ) is consistent with 6.9 wt % germania in the silica core.

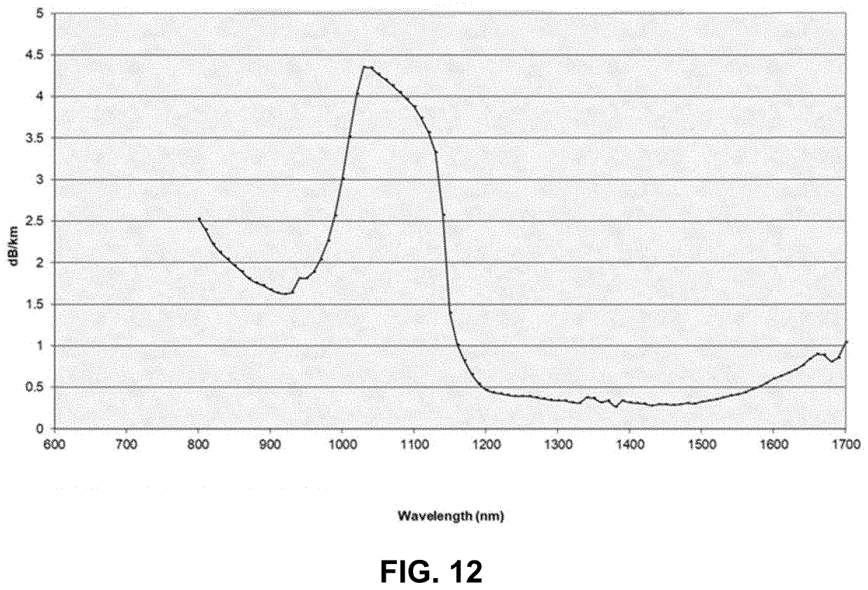

The relatively intense OH absorption peak at 1383 nm shown for the fiber in FIG. 10 is believed to be due to the relatively high temperature (1,200° C.) used in step (c) of the consolidation process. FIG. 12 shows that the intensity of OH absorption peak at 1383 nm was reduced when step (c) was conducted at a temperature of 1,050° C.

### Example 6

### Deposition with GeCl₄ and OMCTS

This example describes fabrication of Ge-doped silica from GeCl₄ and OMCTS. The deposition and consolidation conditions described above for TEOG and OMCTS apply similarly to GeCl₄ and OMCTS. Preform and fiber characteristic achievable from depositions with GeCl₄ and OMCTS are similar to those described above for preforms and fibers obtained from TEOG and OMCTS.

As with TEOG, GeCl4 introduces germania (GeO₂) as a dopant in silica. Formation of germania from GeCl₄ occurs from the reaction

GeCl₄+O₂⇄GeO₂+Cl₂

where “⇄” denotes an equilibrium reaction.

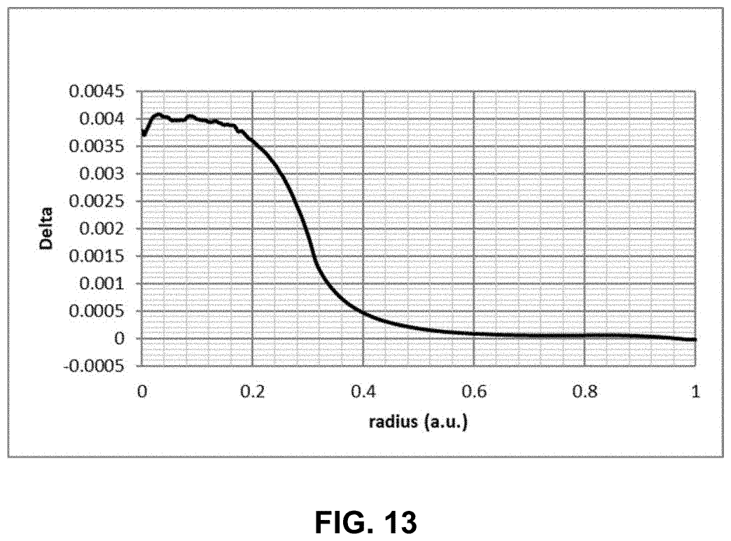

FIG. 13 shows the relative refractive index profile for a preform with a Ge-doped silica core and an undoped silica cladding. The core portion of the preform was made from the precursors GeCl₄ and OMCTS. The cladding portion of the preform was made from OMCTS. The relative refractive index profile is expressed in terms of delta (Δ) as a function of radial position from the centerline for a wavelength of 850 nm.

The preform was made using a burner with the design shown in FIG. 6. For the core portion of the preform, the precursors GeCl₄ and OMCTS were delivered in separate streams in N₂ as a carrier gas to the base of the burner, directed through the fume tube, and combusted to form soot that was deposited on a bait rod. GeCl₄ was delivered at a mass flow rate of 0.55 g/min in a carrier stream of N₂ delivered at a flow rate of 1.0 slpm (standard liters per minute). OMCTS was delivered at a mass flow rate of 3.0 g/min in a carrier stream of N₂ delivered at a flow rate of 0.8 slpm. For the cladding portion of the preform, the flow of the GeCl₄ precursor (and its carrier stream) were terminated and the OMCTS precursor and its carrier stream were maintained. For both the core and cladding portions of the preform, O₂ was included in the fume stream at a flow rate of 1.25 slpm, the pre-mix stream contained 1.2 slpm CH₄ and 1.0 slpm O₂, the supplemental stream contained 6.8 slpm O₂, and the inner shield stream contained 3.5 slpm N₂. The distance of the burner from the surface of the deposited soot was maintained at approximately 11.4 cm.

The bait rod was removed and the resulting soot body was consolidated to form the preform having the relative refractive index profile shown in FIG. 13. During consolidation, the soot body was dried with Cl₂ at 1050° C. for 130 minutes and sintered at 1490° C. for 129 minutes.

A comparison of FIG. 13 with FIGS. 7-9 indicates that the refractive index profile of preforms made from GeCl₄ and OMCTS was similar to the refractive index profiles of preforms made from TEOG and OMCTS. Optical fiber drawn from the preform made from GeCl₄ and OMCTS had a refractive index profile similar to the one shown in FIG. 11 for optical fiber drawn from a preform made from TEOG and OMCTS.

Aspect 1 of the description is:

A method for forming an optical fiber preform comprising:

forming silica particles from a silica precursor;

forming germania particles from a germania precursor;

depositing the silica particles and the germania particles on a substrate to form a soot preform, the substrate having a temperature less than 1,250° C.; and

wherein at least one of the silica precursor and germania precursor is an organic precursor.

Aspect 2 of the description is:

The method of Aspect 1, wherein the forming silica particles comprises flame reaction of the silica precursor and flame reaction of the germania precursor.

Aspect 3 of the description is:

The method of Aspect 1 or 2, wherein the forming silica particles and forming germania particles comprises flame reaction of a mixed feedstock, the mixed feedstock comprising the silica precursor and the germania precursor.

Aspect 4 of the description is:

The method of any of Aspects 1-3, wherein the germania precursor is an organic germania precursor.

Aspect 5 of the description is:

The method of Aspect 4, wherein the organic germania precursor comprises a germanium alkoxide, a germanium alkylalkoxide, a germanium alkyl, or any combination thereof.

Aspect 6 of the description is:

The method of Aspect 5, wherein the organic germania precursor comprises a C₁-C₁₀ germanium alkoxide.

Aspect 7 of the description is:

The method of Aspect 5, wherein the organic germania precursor comprises germanium tetraethoxide.

Aspect 8 of the description is:

The method of any of Aspects 4-7, wherein the silica precursor is an organic silica precursor.

Aspect 9 of the description is:

The method of Aspect 8, wherein the organic silica precursor comprises a siloxane, a silicon alkoxide, an organosilane, a silicon alkylalkoxide, or any combination thereof.

Aspect 10 of the description is:

The method of Aspect 8, wherein the organic silica precursor comprises octamethylcyclotetrasiloxane.

Aspect 11 of the description is:

The method of any of Aspects 4-10, wherein the organic germania precursor comprises germanium tetraethoxide.

Aspect 12 of the description is:

The method of any of Aspects 1-11, wherein the silica particles and the germania particles are deposited simultaneously on the substrate.

Aspect 13 of the description is:

The method of any of Aspects 1-11, wherein the silica particles are deposited on the substrate before the germania particles.

Aspect 14 of the description is:

The method of any of Aspects 1-13, wherein before the forming silica particles and before the forming germania particles, the method further comprises heating the substrate.

Aspect 15 of the description is:

The method of Aspect 14, wherein the substrate is heated with a pre-mix flame.

Aspect 16 of the description is:

The method of any of Aspects 1-15, wherein before the forming silica particles and before the forming germania particles, the method further comprises depositing a layer of silica on the substrate.

Aspect 17 of the description is:

The method of any of Aspects 1-16, wherein the temperature of the substrate is less than or equal to 1,100° C.

Aspect 18 of the description is:

The method of any of Aspects 1-16, wherein the temperature of the substrate is between 600° C. and 1,200° C.

Aspect 19 of the description is:

The method of any of Aspects 1-18, further comprising removing the soot preform from the substrate.

Aspect 20 of the description is:

The method of any of Aspects 1-19, further comprising:

heating the soot preform at a temperature in the range from 500° C. to 1000° C. under a first atmosphere, the first atmosphere comprising O₂.

Aspect 21 of the description is:

The method of Aspect 20, wherein the first atmosphere comprises the O₂ at a concentration of from about 0.5 vol % to about 10 vol % and helium at a concentration of from about 90 vol % to about 99.5 vol %.

Aspect 22 of the description is:

The method of Aspect 20 or 21, wherein after the heating, the method further comprises drying the soot preform with a dehydration agent under a second atmosphere, the second atmosphere comprising O₂.

Aspect 23 of the description is:

The method of Aspect 22, wherein after the drying, the method further comprises heating the soot preform at a temperature greater than or equal to 1,400° C. under a third atmosphere, the third atmosphere comprising O₂.

Aspect 24 of the description is:

The method of any of Aspects 1-19, further comprising drying the soot preform with a dehydration agent under a second atmosphere, the second atmosphere comprising O₂.

Aspect 25 of the description is:

The method of Aspect 24, wherein the second atmosphere comprises the O₂ at a concentration of from about 0.5 vol % to about 10 vol % and helium at a concentration of from about 90 vol % to about 99.5 vol %.

Aspect 26 of the description is:

The method of Aspect 24 or 25, wherein the dehydration agent comprises CCl₄, Cl₂, Br₂, SOCl₂, CO, SiCI₄, or any combination thereof.

Aspect 27 of the description is:

The method of any of Aspects 24-26, wherein the drying occurs at a temperature less than or equal to 1,250° C.

Aspect 28 of the description is:

The method of any of Aspects 24-26, wherein the drying occurs at a temperature of from about 600° C. to about 1,250° C.

Aspect 29 of the description is:

The method of any of Aspects 24-28, wherein after the drying, the method further comprises heating the soot preform at a temperature greater than or equal to 1,400° C. under a third atmosphere, the third atmosphere comprising O₂.

Aspect 30 of the description is:

The method of Aspect 29, wherein the heating under the third atmosphere occurs for a period of time greater than or equal to 30 minutes.

Aspect 31 of the description is:

The method of Aspect 29 or 30, wherein the O₂ of the third atmosphere has a concentration of 0.1 vol % to 1 vol %.

Aspect 32 of the description is:

An optical fiber preform produced by the method of any of Aspects 1-31.

Aspect 33 of the description is:

An optical fiber drawn from the optical fiber preform of Aspect 32.

Throughout this publication, various publications are referenced. The disclosures of these publications in their entireties are hereby incorporated by reference into this application in order to more fully describe the methods, compositions, and compounds herein.

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

What is claimed:

1. A method for forming an optical fiber preform comprising:
forming silica particles from a silica precursor;
forming germania particles from a germania precursor;
depositing the silica particles and the germania particles on a substrate to form a soot preform, the substrate having a temperature less than 1,250° C.; and
wherein at least one of the silica precursor and germania precursor is an organic precursor.

2. The method of claim 1, wherein the forming silica particles comprises flame reaction of the silica precursor and flame reaction of the germania precursor.

3. The method of claim 1, wherein the forming silica particles and forming germania particles comprises flame reaction of a mixed feedstock, the mixed feedstock comprising the silica precursor and the germania precursor.

4. The method of claim 1, wherein the germania precursor is an organic germania precursor, the organic germania precursor comprising a germanium alkoxide, a germanium alkylalkoxide, a germanium alkyl, or any combination thereof.

5. The method of claim 4, wherein the silica precursor is an organic silica precursor, the organic silica precursor comprising a siloxane, a silicon alkoxide, an organosilane, a silicon alkylalkoxide, or any combination thereof.

6. The method of claim 5, wherein the organic silica precursor comprises octamethylcyclotetrasiloxane and the organic germania precursor comprises germanium tetraethoxide.

7. The method of claim 1, wherein the germania precursor is GeCl₄ and the silica precursor is an organic silica precursor.

8. The method of claim 7, wherein the organic silica precursor comprises octamethylcyclotetrasiloxane.

9. The method of claim 1, wherein before the forming silica particles and before the forming germania particles, the method further comprises heating the substrate.

10. The method of claim 9, wherein the substrate is heated with a pre-mix flame.

11. The method of claim 1, wherein before the forming silica particles and before the forming germania particles, the method further comprises depositing a layer of silica on the substrate.

12. The method of claim 1, wherein the temperature of the substrate is between 600° C. and 1,200° C.

13. The method of claim 1, further comprising:
heating the soot preform at a temperature in the range from 500° C. to 1000° C. under a first atmosphere, the first atmosphere comprising O₂.

14. The method of claim 13, wherein the first atmosphere comprises the O₂ at a concentration of from about 0.5 vol % to about 10 vol % and helium at a concentration of from about 90 vol % to about 99.5 vol %.

15. The method of claim 13, wherein after the heating, the method further comprises drying the soot preform with a dehydration agent under a second atmosphere, the second atmosphere comprising O₂.

16. The method of claim 15, wherein after the drying, the method further comprises heating the soot preform at a temperature greater than or equal to 1,400° C. under a third atmosphere, the third atmosphere comprising O₂.

17. The method of claim 1, further comprising drying the soot preform with a dehydration agent under a second atmosphere, the second atmosphere comprising O₂.

18. The method of claim 17, wherein the dehydration agent comprises CCl₄, Cl₂, Br₂, SOCl₂, CO, SiCl₄, or any combination thereof.

19. The method of claim 17, wherein the drying occurs at a temperature of from about 600° C. to about 1,250° C.

20. The method of claim 17, wherein after the drying, the method further comprises heating the soot preform at a temperature greater than or equal to 1,400° C. under a third atmosphere, the third atmosphere comprising O₂.

21. An optical fiber preform produced by the method of claim 1.

22. An optical fiber drawn from the optical fiber preform of claim 21.
